(19) United States
(12) Patent Application Publication
(10) Pub. No.: US 2015/0347928 A1
(43) Pub. Date: Dec. 3, 2015

(54) SEAT ASSIGNMENT

(71) Applicant: Amadeus S.A.S., Sophia Antipolis (FR)

(72) Inventors: Denis Boulanger, Grasse (FR); Luc Choubert, Biot (FR); Raphael Saban, Antibes (FR); Mathieu Chan Noon Chung, Lausanne (CH)

(73) Assignee: Amadeus S.A.S., Sohpia Antipolis (FR)

(21) Appl. No.: 14/291,237

(22) Filed: May 30, 2014

(51) Int. Cl. G06Q 10/02; G06Q 50/00

(52) U.S. Cl. CPC G06Q 10/02; G06Q 50/01

(57) ABSTRACT

Methods, systems, and computer program products for assigning seats of passenger-transport vehicles to passengers. The passengers are subdivided into a plurality of groups. The passengers included in each group are connected by social-network relations and have less than a maximum number of social-network relations to other passengers outside of the group. Breaks of the social-network relations between the passengers are minimized when the passengers are subdivided into the groups. In response to one of the passengers being excluded from the groups, one of the groups is determined that includes at least one included passenger with at least one of the social-network relations to the excluded passenger to thereby increase the size of the group by adding the excluded passenger.

### BACKGROUND

The invention generally relates to computers and computer software and, in particular, to methods, systems, and computer program products for assigning seats of passenger-transport vehicles to passengers.

Typically, passengers that travel together also buy their tickets together and may choose the option for a group reservation. Having made a group reservation, they are connected by a reservation link that normally assures they are seated next to each other.

Improved methods, systems, and computer program products are needed to assign seats of passenger-transport vehicles to passengers.

### SUMMARY

Embodiments of the invention generally comprise methods, systems, and computer program products to assign seats of passenger-transport vehicles to passengers. The passengers are subdivided into a plurality of groups. The passengers included in each group are connected by social-network relations and have less than a maximum number of social-network relations to other passengers outside of the group. Breaks of the social-network relations between the passengers are minimized when the passengers are subdivided into the groups. In response to one of the passengers being excluded from the groups, one of the groups is determined that includes at least one included passenger with at least one of the social-network relations to the excluded passenger to thereby increase the size of the group by adding the excluded passenger.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is an exemplary graph G1 corresponding to a network of relations between passengers.

FIG. 2 shows the graph G1 wherein passengers with a high total number of relations, i.e., the popular passengers, are marked by white-centered circles.

FIG. 3 shows the graph G1 in which groups that contain only passengers who are related to each other are marked by black edgings.

FIG. 4 illustrates merging procedures, marked by arrows M₁ and M₂, handling non-popular, non-included passengers of graph G1.

FIG. 5 illustrates merging process M₃ and group creation for popular passengers in the graph G1.

FIG. 6 is an exemplary graph G2 corresponding to a network of relations between passengers.

FIG. 7 shows the graph G2 with groups that contain only passengers who are related to each other, marked by black edgings.

FIG. 8 illustrates merging procedures, marked by arrows M₄ and M₅, handling the first two non-included passengers P₆ and P₇ of graph G2.

FIG. 9 illustrates alternative merging procedures, marked by arrows M₆ and M₇, handling the first two non-included passengers P₆ and P₇ of graph G2.

FIG. 10 illustrates merging procedures, marked by arrows M₈ and M₉, handling the next two non-included passengers P₅ and P₁₀ of graph G2, following the merging procedure illustrated by FIG. 8.

FIG. 11 illustrates merging procedures, marked by arrows M₈ and M₉, handling the next two non-included passengers P₅ and P₁₀ of graph G2, following the merging procedure illustrated by FIG. 9.

FIG. 12 shows a flow chart of an exemplary group split process.

FIG. 13 illustrates exemplary building blocks of link-seat-configurations.

FIG. 14 shows an exemplary arrangement of partially occupied seating space of a vehicle, separated by an aisle A1, illustrating this arrangement before and after seats are assigned to a group of five passengers.

FIG. 15 shows an exemplary arrangement of partially occupied seating space of a vehicle, separated by an aisle A2, illustrating this arrangement before and after seats are assigned to a group of seven passengers.

FIG. 16 shows an exemplary computer system arranged to carry out the methodologies described herein.

### DETAILED DESCRIPTION

Seat assignment is the act of assigning seats of a vehicle to a group of passengers in which an individual, unoccupied seat is assigned to each passenger. This seat assignment may be performed for various passenger-transport vehicles, such as airplanes, railways, ships, and/or buses. In the seat assignment procedure described herein, social network relations of passengers to other passengers are taken into account. These social network relations between the passengers may include relationships on online communication platforms, such as online platforms relating to career, information, or entertainment issues.

The allocation of seats to passengers can be represented by a logic representation of passengers and social network relations between them in the form of at least one graph with vertices and edges, and may be applied to each of the disjoint graphs, separately. Each of these disjoint graphs comprises only vertices that are connected to at least one other vertex of that graph. In a graph, the passengers are represented by the vertices and the social relations between the passengers are represented by the edges. The subdivision of the graph into groups of vertices (i.e., groups of passengers) is performed in such a way that a group contains only vertices, which are connected via edges (i.e., relations) to each other vertex in that group. Additionally, only vertices which have less than a given maximum number of connections to other vertices of the graph are included in a group.

Vertices that possess at least the maximum number of connections to other vertices (i.e., passengers) may be referred to as popular passengers. The maximum number of relations to other passengers, defining a popular passenger, may be dependent on various parameters, such as the total number of vertices in the graph or on the highest number of connections a single vertex has to other vertices in the graph. In turn, all passengers having a number of connections equal to or less than the maximum number of connections that defines a popular passenger may be referred to as non-popular passengers. To avoid the breaking of a large number of relations due to the subdivision of the graph, the lower limit of connections of a vertex that defines a popular passenger might be set to five, for example.

The groups of vertices (i.e., groups of passengers) are chosen in such a way that the number of broken connections resulting from the subdividing is minimized. This minimizing may, for example, be done by calculating the number of broken relations for each conceivable subdivision of the graph, respecting all given constraints mentioned below, and choosing the subdivision that causes the fewest broken relationships. Following the subdivision, vertices which have not yet been included into a group, are added to groups in order to include every vertex into any one of the groups to which it has a connection.

In general, a group has a connection to a vertex and vice versa if at least one vertex within the group has a connection to this non-included vertex. The same correlation applies to connected vertices within different groups. Therefore, a group is connected to another group when at least one connection between two vertices, one in each group, exists. In this context, breaking a relation means cutting an edge in the graph corresponding to that relation. After seat assignment, those broken relations may result in (former) related passengers being seated spatially apart from each other. However, in the course of these activities, cut edges (i.e., broken relations) of the graph are still available for further evaluation. Thus, the passengers are still correlated even though some of their relations may have been broken during the subdivision of the graph.

The assignment of seats, as described herein, does not use such an all-possible-combination approach to seat allocation. Instead, groups of passengers are selected that have a small group size compared to the entirety of passengers to be seated, which is represented by the graph of vertices. When assigning seats to those groups, the relations between the passengers no longer have to be respected because passengers having a relation to each other are already grouped together. Thus, the sequential seat assignment to those groups as described herein has a complexity related to n (i.e., it is of the order O(n)), wherein n is the total number of passengers to be seated, i.e., the number of vertices in the graph representing the passengers and the relations between them. Hence, seat assignment as described herein requires less processing time, or processing power, than an all-possible-combination approach to seat allocation.

In general, many seats of a passenger-transport vehicle (e.g., an airplane) are allocated to passengers who travel in groups formed by a reservation link resulting from a prior booking, indicating that those passengers belong together. Thus, if they have booked adjacent seats, they will be seated next to each other. In some embodiments, passengers with a reservation link are not mapped onto the graph as vertices and, therefore, the approaches for seat assignment described herein are not applied to them.

In other embodiments, the size of groups formed by the subdivision of the graph as described above is limited to two or three vertices (i.e., passengers) per group. Inherently, due to the condition that the number of cut edges (i.e., broken relations) is minimized, groups consisting of three vertices will be the preferred outcome of the subdivision of the graph. In these groups of two or three vertices, each vertex is connected to each other vertex of the group. Such a group consisting of three vertices, where each vertex is connected to each other vertex of the group, is further referred to as trio.

Depending on the relations between the passengers, it may happen that one of the non-included vertices of the graph may have more connections to a certain group than to any of the other groups formed by the subdivision of the graph. In response to such a graph, the above-mentioned vertex may be added to the group to which it has the highest number of connections.

As a result of the subdivision of the graph, in some embodiments, groups containing different numbers of vertices may be formed, and some vertices may have not been assigned to a group. In an exemplary graph topology, after the subdivision of the graph, one group may consist of two vertices, another group may consist of three or more vertices, and there may still be some non-included vertices. One of these non-included vertices could be connected to a group of three vertices and to a group of two vertices. To resolve such a case, a vertex that has not yet been assigned to a group is added to the group which contains the smallest number of vertices and has at least one connection to that vertex.

In some embodiments, a non-included vertex has a number of connections to individual groups formed by the subdivision of the graph that differs from other vertices. This vertex is added to the group to which the vertex has the highest number of connections. Thus, the number of broken connections (i.e., the relations between passengers) between vertices is minimized

In some vehicles, the number of seats in a row may be limited because, for example, the number of seats in an airplane seat row is restricted by the size of the fuselage. Hence, in some embodiments, the number of vertices per group may have a given upper limit that has to be chosen according to the type and size of the vehicle. If this limit is not respected, the formation of oversized groups could lead to a split of these groups, as described below, during the seat assignment because there would not be enough seating space to place the passengers in those groups in a coherent seat configuration.

The most suitable group assignment for non-included vertices is the group assignment that breaks the fewest connections between vertices. In order to find the most suitable group assignment for non-included vertices, the total number of connections to other vertices in the graph is taken into account to determine the chronological order in which the non-included vertices with less than the given maximum number of connections to other vertices, i.e., non-popular passengers, are added to groups. The addition of those non-included vertices to groups is sequenced by their number of total connections in the graph, and the vertex with the largest total number of connections in the graph is processed first. In some embodiments, the previously disregarded vertices with more than the given maximum number of connections to other (i.e., popular passengers) in the graph may be considered to determine the chronological order in which the non-included vertices are added to groups and, therefore, may be chosen first during this adding process.

In some cases, groups formed by the subdivision of the graph, that are connected to non-included vertices may have the same group size, which is smaller than the given maximum group size (i.e., the maximum number of vertices per group). Additionally, still other manifestations of a graph may contain a first non-included vertex with an identical number of connections to at least two groups and at least one other non-included-vertex that is connected to any of those groups. The number of identical connections that the first non-included vertex has to those groups is also the highest number of connections this vertex has to any group in the graph. In such a case, the total number of connections of a group to the non-included vertices is considered. A group-mark number may be created for each group as a criterion defining which group is the most suitable one for a non-included vertex. The group-mark number can be calculated as total number of connections of a group to all non-included vertices minus the number of connections a group has to popular passengers minus the number of connections that a group has to the first non-included vertex. The first non-included vertex is added to the group that has the smallest group-mark number with respect to that first non-included vertex. In some embodiments, the previously disregarded vertices with more than the given maximum number of connections to other vertices (i.e., popular passengers) in the graph may be included in the adding process described above.

In other embodiments, after the subdivision of the graph and the adding of vertices into groups, there may still be at least two vertices that have not been added to a group one of these vertices may correspond to a previously excluded vertex that has more than a given maximum number of connections to other (i.e., popular passengers) in the graph. In such a case, a new group is created that contains those at least two non-included vertices. When forming such a group, the given maximum group size mentioned above may be exceeded.

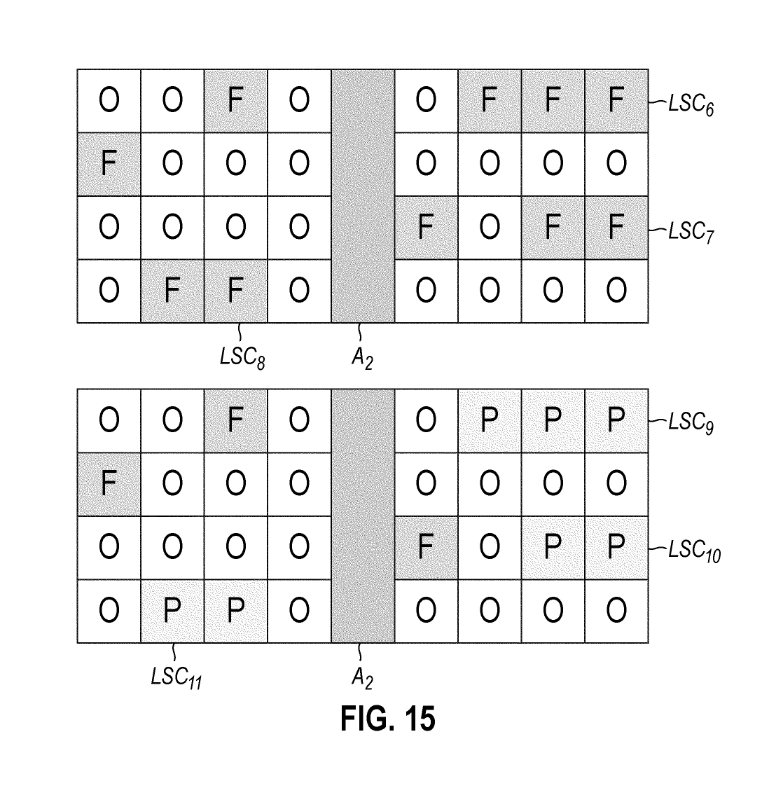

In general, some seats may already be occupied by other passengers and, therefore, are unavailable in the seat-assignment process. Due to this constraint, it is possible that the size of groups of vertices (i.e., groups of passengers) formed by the subdivision of the graph can exceed the number of unoccupied seats in the largest link-seat-configuration. A link-seat-configuration might be made up of any combination of unoccupied side by side, face to face, cross aisle, on edge, front to back, or slantwise seat conjunctions, as illustrated by FIG. 15. As a consequence, the groups of vertices (i.e., passengers) are split. Splitting a group during a seat assignment stands for dividing that group into not necessarily equal subgroups for the purpose of seat assignment.

In some embodiments, the number of vertices in a group may exceed the number of seats in the largest available link-seat-configuration by at least two. In that case, each of those unoccupied seats is allocated to a vertex (i.e., passenger) of the group until all previously unassigned seats in the link-seat-configuration are assigned. All vertices (i.e., passengers) that have still not been assigned a seat constitute a new group of vertices, which is referred to as a remainder group. Provided another unoccupied link-seat-configuration exists with at least the number of seats that equals the number of vertices in the remainder group, each of those unoccupied seats is allocated to a vertex (i.e., passenger) of the remainder group, until all vertices of the remainder group have been assigned a seat. In the case in which no link-seat-configuration with enough seating space for the remainder group exists and the number of vertices in the remainder group exceeds the number of unoccupied seats in any available link-seat-configuration by at least two, the largest unoccupied link-seat-configuration available is chosen. Each of those unoccupied seats is allocated to a vertex (i.e., passenger) of the remainder group until all previously unassigned seats in the largest available unoccupied link-seat-configuration are assigned. All vertices (i.e., passengers) that have still not been assigned a seat constitute a new group of vertices, which is referred to as residual remainder group. Provided another available link-seat-configuration exists with at least the number of unoccupied seats that equals the number of vertices in the residual remainder group, each of those unoccupied seats is allocated to a vertex (i.e., passenger) of the residual remainder group until all vertices of the residual-remainder group have been assigned a seat.

The activities mentioned above may be carried out repeatedly by a computer until a seat of any number of link-seat-configurations has been assigned to each vertex (i.e., passenger) of the group.

In some embodiments, the number of vertices in a group, a remainder group, or a residual remainder group might exceed the number of unoccupied seats in the largest link-seat-configuration by exactly one. In that case, an unoccupied seat of the next smaller available link-seat-configuration is assigned to each vertex (i.e., passenger) in the group or remainder group until each unoccupied seat of the next smaller available link-seat-configuration has been assigned. The vertices that have not been assigned an unoccupied seat of the next-smaller available link-seat-configuration constitute a rest group of vertices. Thereafter, seats of an available link-seat-configuration that has a number of seats equal to or higher than the number of vertices in that rest group are assigned to the vertices of that rest group. A link-seat-configuration large enough to include that rest group always exists because of the availability of the largest link-seat-configuration that contained only one seat less than the number of vertices in the group that resulted from the subdividing of the graph.

In some embodiments, all the activities comprised in the assignment of seats are performed automatically by a computer system, e.g., the computer system described herein. Some embodiments relate to a computer system for producing a seat assignment of a vehicle. The computer system is programmed with a computer program that may be stored on a non-transitory computer-readable storage medium of the computer system, for example, a magnetic or optical data disk. The computer program has instructions which, when executed on the computer, cause the assignment of seats described herein to be carried out. For example, the instructions may cause the computer to produce a seat assignment of a vehicle, wherein given social network relations between passengers are used in the seat assignment. Passengers having a social network relation with at least one of the other passengers and the social network relations of the passengers correspond to a graph with vertices and edges. The passengers correspond to the vertices of the graph and the social-network relations correspond to the edges of the graph. The graph covers vertices connected to at least one other vertex in the graph by subdividing the graph into groups of vertices. The subdividing encompasses vertices in each group of vertices that are connected to each other vertex in the group of vertices and have less than a given maximum number of connections to other vertices in the graph. The groups of vertices are subdivided by minimizing the cuts of edges between the vertices in the graph. In response to at least one vertex not being included in any group of vertices as a result of the subdividing, the at least one non-included vertex is added into a group connected to the at least one non-included vertex via at least one edge, thereby increasing the size of the group obtained from the subdividing.

Hence, the seat assignments take into account the relationships between passengers to be seated. With the assistance of a computer, a multitude of vehicle passengers is subdivided into groups of related passengers. Thereafter, seats are assigned to the groups of passengers. If there are not enough unoccupied adjacent seats to seat such a group together, a split of the group is performed. This split is performed in such a way that at least two related passengers in the group are seated adjacent to each other.

The seat assignments may not always result in the best conceivable group distribution. For example, a vertex (i.e., a passenger) may be added to a group to which it does not have the most connections, or more connections than necessary may be broken. In a few seat assignment scenarios depending on the manifestation of the graph, a vertex (i.e., a passenger) may not be added to any group at all and a single, isolated seat may be assigned to the passenger corresponding to that vertex. If a group of passengers is split, when there are too few available link-seat-configurations in the vehicle, the method of splitting groups indicated in the method claims will also assign unoccupied single seats to passengers, disregarding the constraint that no passenger should be assigned a seat separated from other passengers having a relation to him or her, in order to seat all the passengers in the vehicle.

The method of assigning seats of a vehicle and various optional additional aspects of the method is now further described by means of examples that are illustrated by the figures.

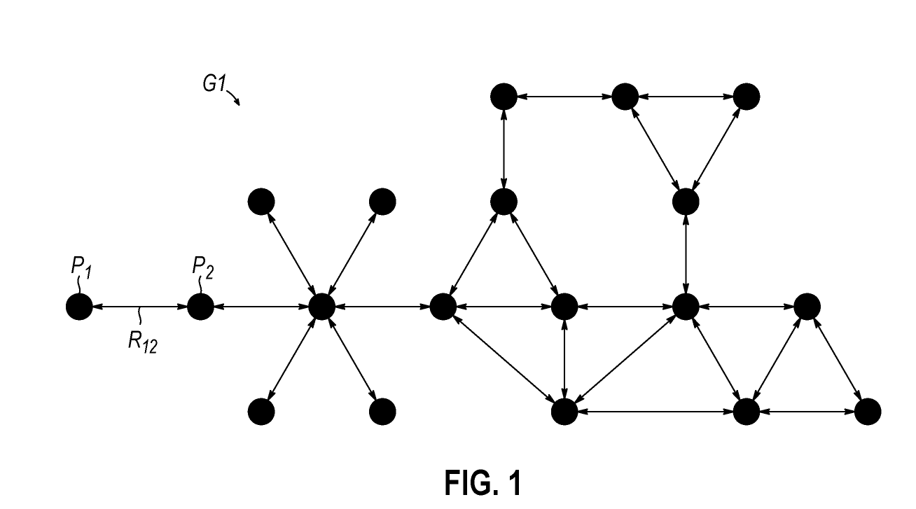

### Exemplary Seat Assignment to Passengers Connected Via Social Relations; FIG. 1 to FIG. 5

For purposes of description, the following exemplary description is simplified to include less than twenty passengers and to choose the arrangement of the relations between the passengers in order to show several activities carried out by the assignment of seats. A person of ordinary skill in the art will appreciate that the number of relations between passengers may differ from that described.

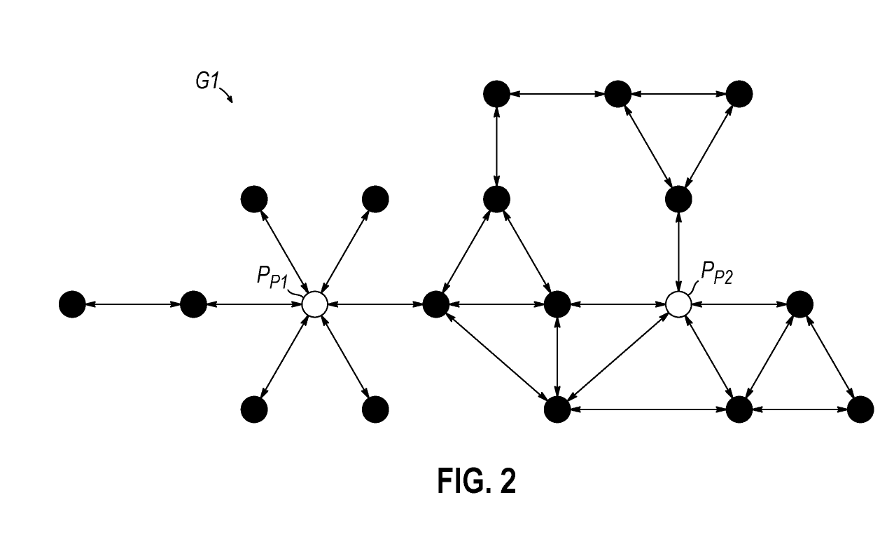

In FIG. 1, a representative graph G1 includes passengers and social relations between the passengers. The graph G1 consists of 19 vertices corresponding to passengers and 26 edges corresponding to relationships or relations between the passengers. Therein, P₁ and P₂ correspond to different specific passengers and R₁₂ to a social relation between those specific passengers. In order to minimize the number of broken relations caused by the subdivision of the graph G1, popular passengers P_{P1}, P_{P2} are determined and are shown in FIG. 2 as open circles. As mentioned above, popular passengers have more than a given maximum number of relations relative to other passengers.

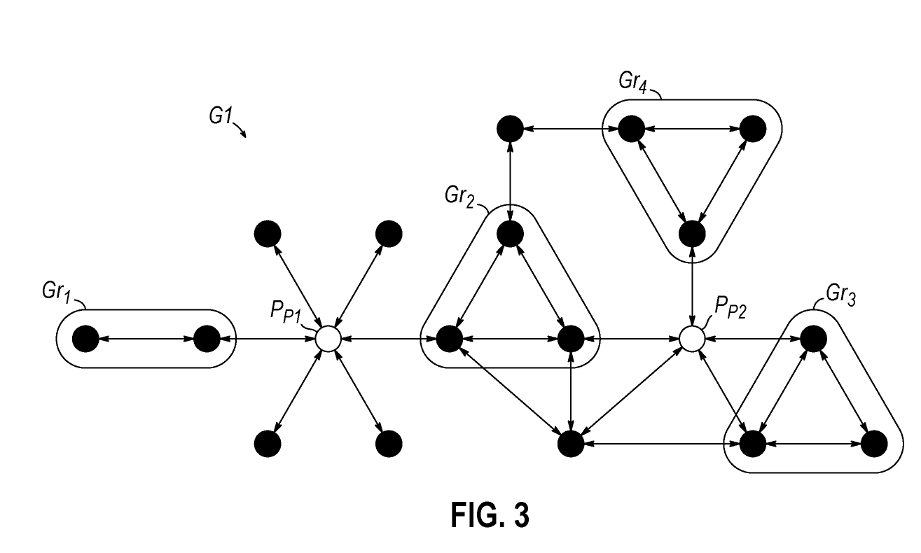

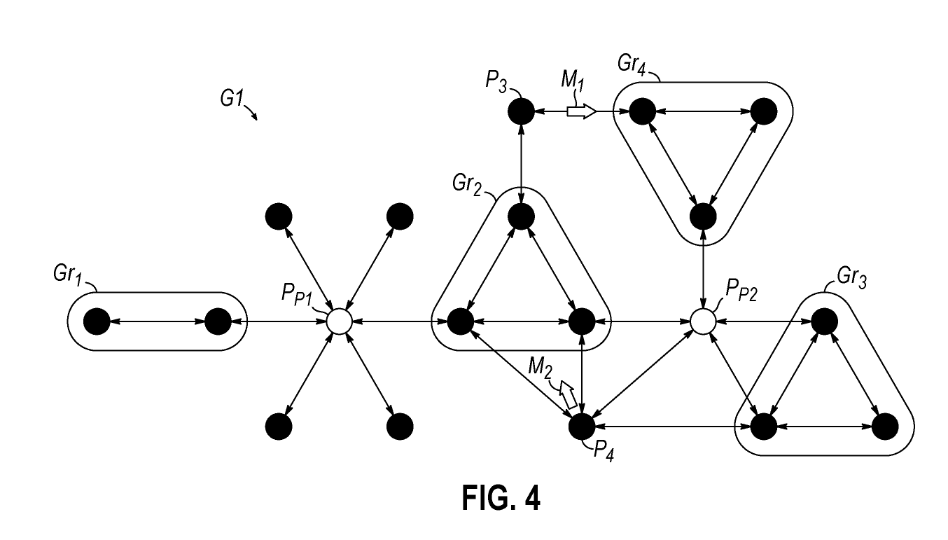

In graph G1, a maximum number of relations defining a popular passenger may be set equal to four. These popular passengers are disregarded during the subsequent subdivision of graph G1, illustrated by FIGS. 3 and 4. Carrying out the activities illustrated by FIG. 3, the graph is subdivided into four groups and the maximum group size is set to four passengers. In order to break as few relations as possible, groups Gr₂, Gr₃ and Gr₄ containing three passengers and another group Gr₁ containing two passengers are chosen. Those groups Gr₁, Gr₂, Gr₃ and Gr₄ only contain passengers that have relations to each of the other passengers with which they are grouped.

Following the formation of groups of passengers, i.e., the subdivision of the graph described above, the non-included passengers P₃ and P₄, who are not popular passengers, are added to an appropriate group. Because P₄ has the largest number of relations among the non-included, non-popular passengers, passenger P₄ is prioritized for the adding process. Each group to which passenger P₄ is connected has an identical group size of three passengers, which is less than the maximum group size. Therein, passenger P₄ has two relations to group Gr₂ and only one relation to group Gr₃ Therefore, group Gr₂ is a more appropriate group for passenger P₄ than group Gr₃. Indeed, adding of passenger P₄ to group Gr₃ would break two relations between group Gr₂ and P₄, whereas choosing group Gr₂ would break only a single relation, namely the relation between group Gr₃ and passenger P₄. Hence, P₄ is added to group Gr₂ by the activity M₂, as illustrated by FIG. 4. As a consequence, group Gr₂ has reached its maximum group size, so no further passenger may be added to the group Gr₂ For the remaining non-included, non-popular passenger P₃ only group Gr₄ can be chosen now, since this group is the only group connected to passenger P₃, which has not yet reached the maximum group size of four passengers per group. Hence, passenger P₃ is added to group Gr₄ by the activity M₁, as illustrated by FIG. 4.

After all non-popular passengers that share relations to at least one non-popular passenger in group G1 have been added to a group by the described embodiment, appropriate groups are chosen for the previously disregarded popular passengers.

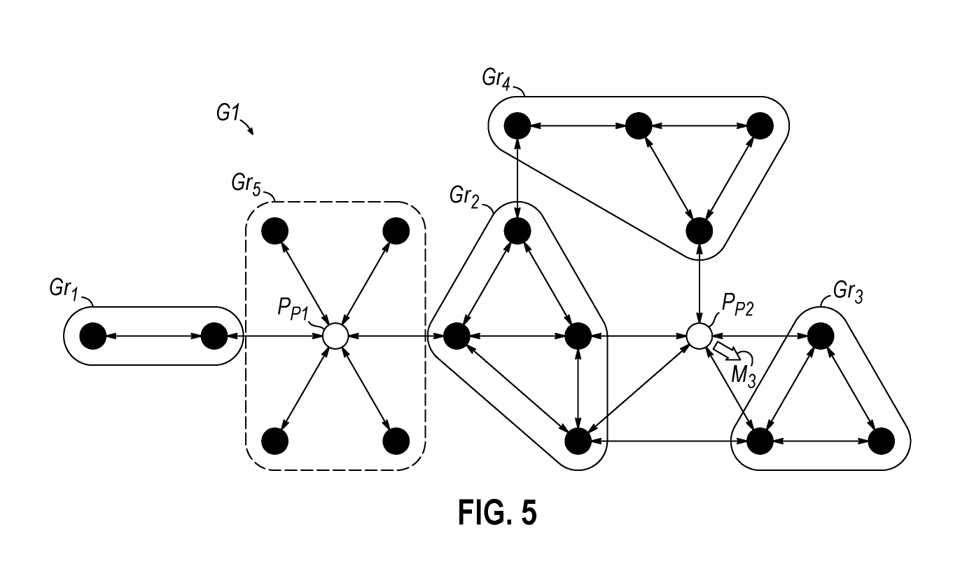

As shown in FIG. 5, there are two remaining popular passengers, P_{P1} and P_{P2}, of whom passenger P_{P1} has six relations to other passengers in the graph and passenger P_{P2} has five relations to other passengers in the graph. Because the passenger with largest number of relations among the remaining non-included passengers is prioritized, P_{P1} is initially chosen for a group assignment. In this embodiment, passenger P_{P1} is connected to four passengers who are only connected to passenger P_{P1} and are not connected to any other passenger of group G1. As a consequence of this special grouping, a new group Gr₅ is formed that includes passenger P_{P1} and all passengers who are only connected to this popular passenger. Because passenger P_{P2} is the last remaining passenger not yet included into a group, a group for passenger P_{P2} is chosen accordingly. The popular passenger P_{P2} has relations to the three groups: Gr₂, Gr₃ and Gr₄. Because group Gr₂ and group Gr₄ have already reached the maximum number of passengers per group, the only feasible adding procedure M₃ is applied to passenger P_{P2}, in accordance with the representative embodiment, as illustrated by FIG. 5.

As a result of carrying out the activities mentioned above, groups of passengers have been formed out of the graph G1 in such a way that every passenger is included in a group. These groups can subsequently be used to assign a seat to each passenger in such a group.

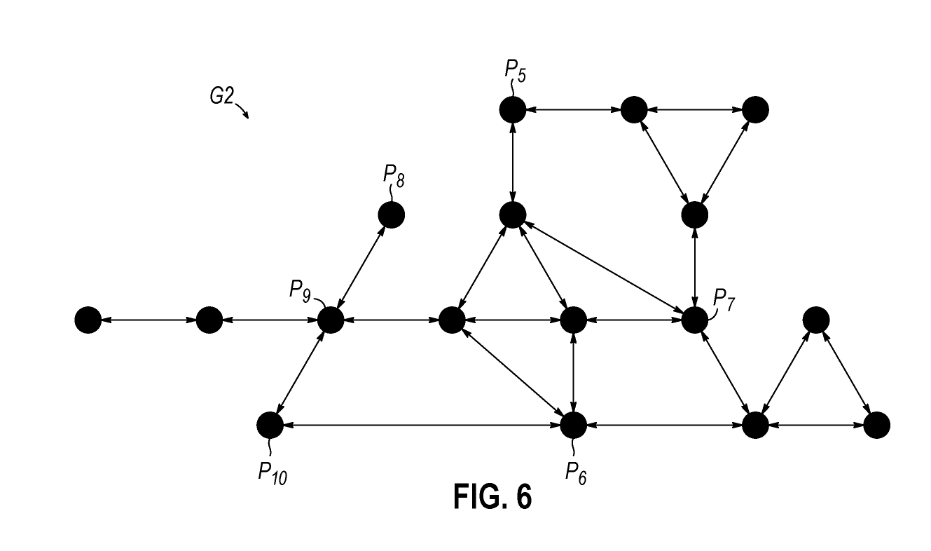

### Second Exemplary Seat Assignment to Passengers Connected Via Social Relations; FIG. 6 to FIG. 11

FIG. 6 illustrates a different manifestation of a graph G2, representing passengers and social relations between the passengers. The graph G2 consists of 17 vertices corresponding to passengers and 24 edges corresponding to relations between the passengers. In this embodiment, which is applied to graph G2, the maximum number of popular passengers is set equal to four. Because no passenger of graph G2 has more relations to other passengers of the graph than this given maximum number, there are no popular passengers evident in the graph G2. In the described embodiment, the maximum group size is set equal to four passengers per group.

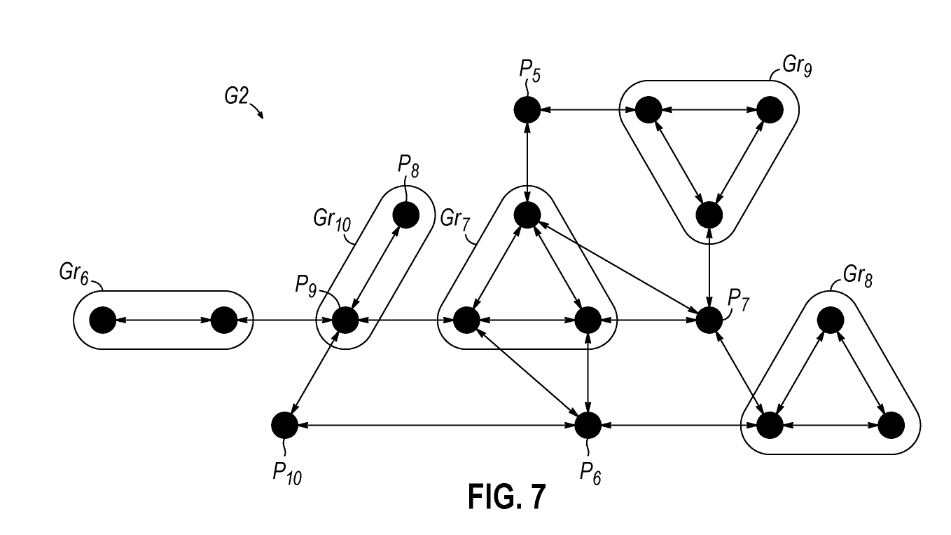

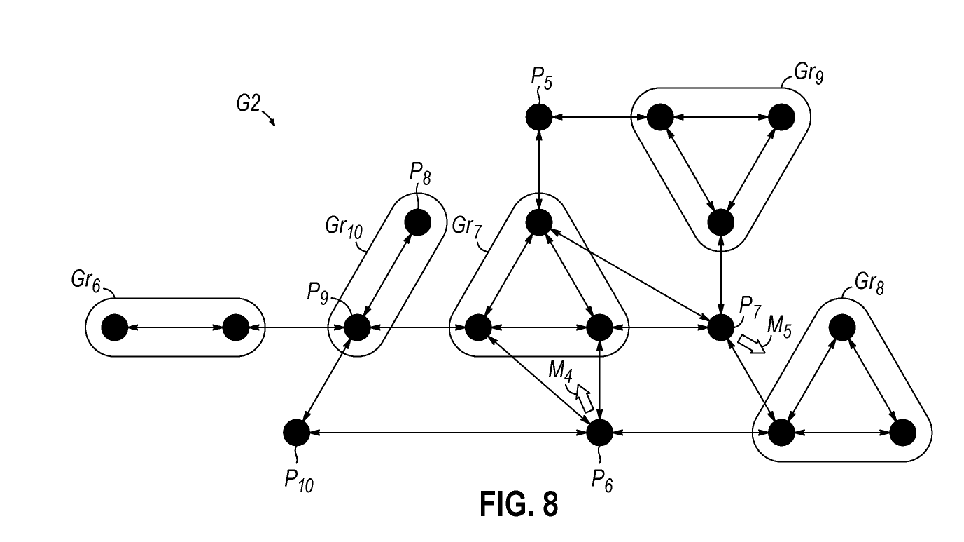

Carrying out the activities illustrated by FIG. 7, the graph G2 is subdivided into five groups. These groups Gr₆, Gr₇, Gr₈, Gr₉ and Gr₁₀ are chosen during the subdivision in such a way that each of those groups contains only passengers who have relations to the other passengers with whom they are grouped. In order to break as few relations as possible, groups Gr₇, Gr₈ and Gr₉ containing three passengers and groups Gr₆ and Gr₁₀ containing two passengers are chosen. Because passenger P₈ and passenger P₁₀ lack a relation to each other and are only connected via passenger P₉, forming a group out of passengers P₈, P₉ and P₁₀ is prohibited during this subdivision activity, since the formation of a group in this activity requires each passenger to be related to each other passenger in the group to be formed. Subsequent to the subdivision of the graph, the non-included passengers P₅, P₆, P₇ and P₁₀ are added to an appropriate group, as illustrated by FIG. 8 to FIG. 11. Since passengers P₆ and P₇ have an equal number of relations, which is the highest number of relations among the non-included passengers, the sequence in which passengers P₆ and P₇ are processed can be arbitrarily chosen.

If vertex for passenger P₆ is chosen first, it is added to group Gr₇, as shown in FIG. 8, because Gr₇ is the group with which the vertex for passenger P₆ has the most connections and, therefore, is the most appropriate group for passenger P₆. Thus, vertex for P₆ is added to group Gr₇ by the adding process M₄, as illustrated by FIG. 8. Even though group Gr₇ would also be the most appropriate group for passenger P₇ the addition of passenger P₆ to group Gr₇ causes group Gr₇ to reach the given maximum group size and, therefore, group Gr₇ is not accessible for passenger P₇. Because the two remaining adding options for the vertex for passenger P₇, groups Gr₈ and Gr₉, are equivalent, another decision criterion is implemented. This decision criterion, the group-mark number mentioned above, is calculated separately for the groups Gr₈ and Gr₉ with respect to the non-included vertex for passenger P₇. It is calculated for group Gr₈ as follows: total number of connections group Gr₈ has to passengers P₅ and P₇, which are the two non-included vertices connected to Gr₈, minus the number of connections that group Gr₈ has to popular passengers minus the number of connections group Gr₈ has to passenger P₇. The group mark number for group Gr₉ is calculated accordingly. From these calculations, the group-mark-numbers 2−0−1=1 for group Gr₉ and 1−0−1=0 for group Gr₈ result with respect to the vertex for passenger P₇. As the group-mark number for group Gr₈ is smaller than for group Gr₉, group Gr₈ is the more appropriate group for vertex P₇. Thus, the vertex for passenger P₇ is added to group Gr₈ by the adding process M₅, as illustrated by FIG. 8.

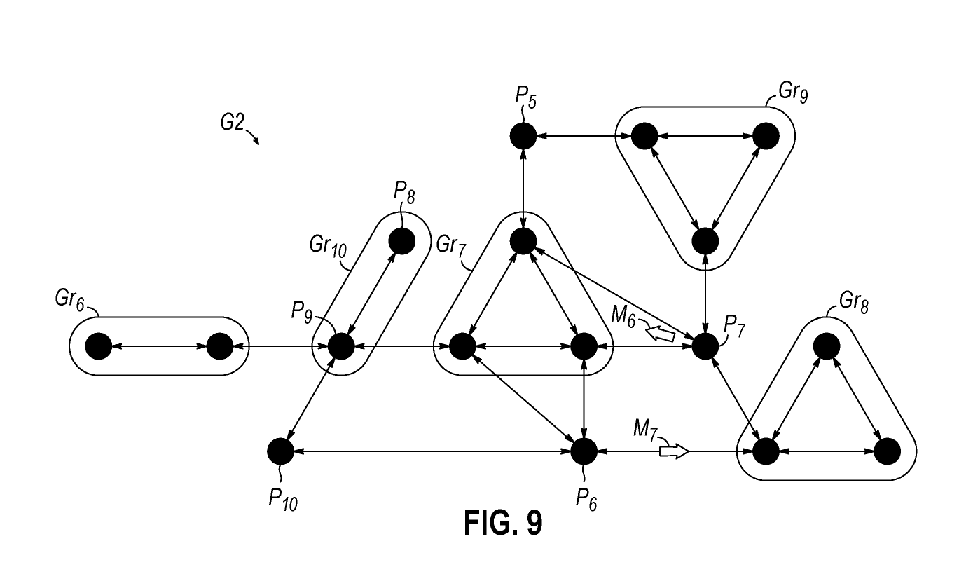

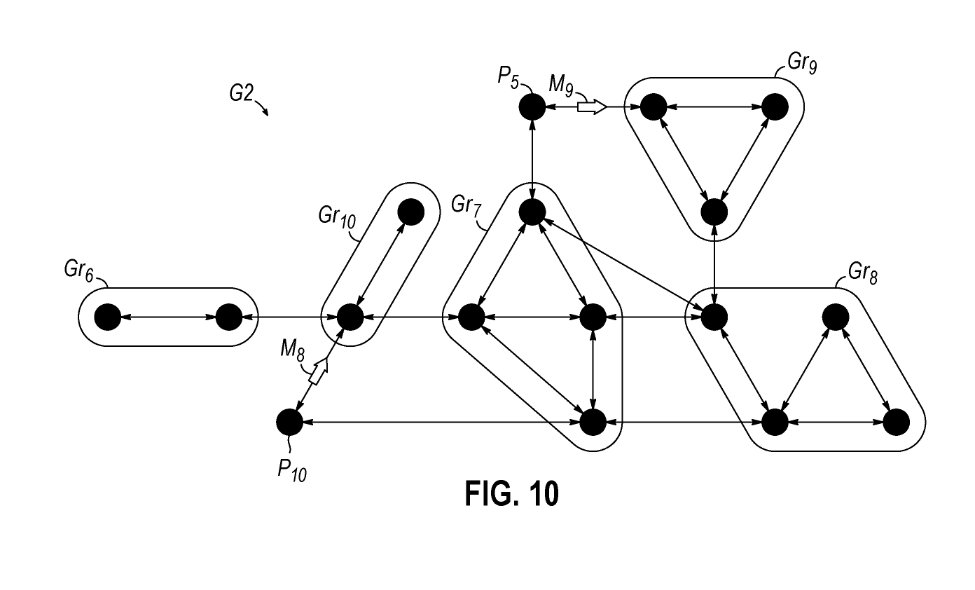

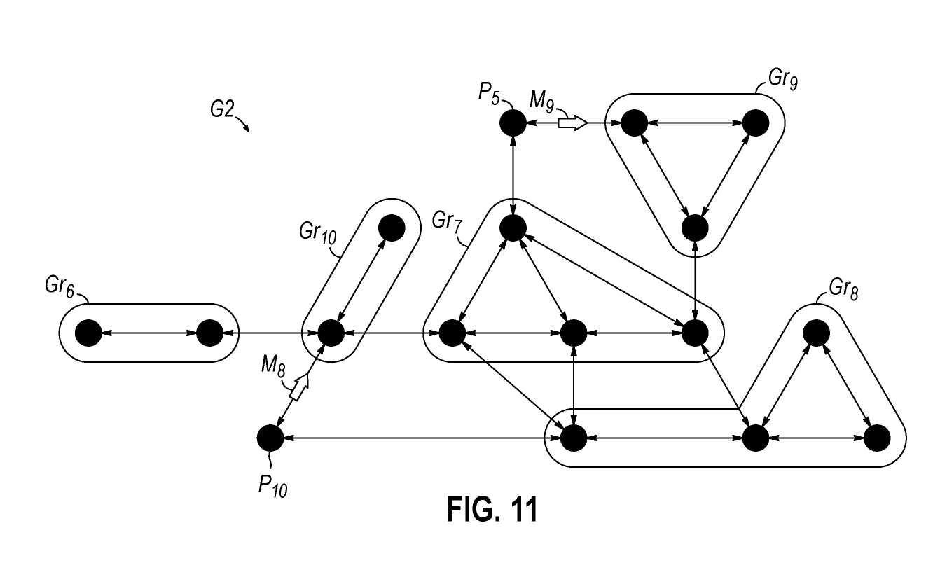

Alternatively, if the vertex for passenger P₇ is chosen first, it is added to group Gr₇, as shown in FIG. 9, since Gr₇ is the group with which the vertex for passenger P₇ has the most connections and, therefore, is the most appropriate group for P₇. Thus, the vertex for passenger P₇ is added to group Gr₇ by adding process M₆, as illustrated by FIG. 9. Even though group Gr₇ would also be the most appropriate group for passenger P₆, as a result of the addition of passenger P₇ it has already reached the given maximum group size and is therefore not accessible for passenger P₆. Since only one adding option for the vertex for passenger P₆ remains, it is added to group Gr₈ by adding process M₇. FIG. 10 and FIG. 11 illustrate two different outcomes depending on the sequence of the adding processes of passengers P₆ and P₇. FIG. 10 corresponds to passenger P₆ being chosen first for the adding process and FIG. 11 corresponds to passenger P₇ being chosen first for the adding process.

Subsequent to the adding processes applied to the vertices for passengers P₆ and P₇, the two non-included vertices for passengers P₅ and P₁₀ are now added to appropriate groups, in an arbitrarily chosen sequence as their total number of connections to other vertices in the graph is identical. The vertex for passenger P₅ is connected to groups Gr₇ and Gr₉, but group Gr₇ has already reached the given maximum group size. So the only remaining adding option for the vertex for passenger P₅ is the group Gr₉. As illustrated by FIG. 10 and FIG. 11, passenger P₅ is added into group Gr₉ by adding process M₉. Since all other vertices have been added into groups, the vertex for passenger P₁₀ is the only remaining non-included vertex. It is connected to two groups, Gr₁₀ and Gr₈. As Gr₈ has already reached the given maximum group size, the vertex for passenger P₁₀ is added to group Gr₁₀ by adding process M₈. Choosing the sequence of the adding processes of passengers P₅ and P₁₀ differently leads to the same outcome. The adding processes for passengers P₅ and P₁₀ are interchangeable because passengers P₅ and P₁₀ are not connected to the same groups.

As a result of carrying out the activities mentioned above, groups of passengers have been formed out of the graph G2 in such a way that every passenger is included in a group. These groups can subsequently be used to assign a seat to each passenger in such a group.

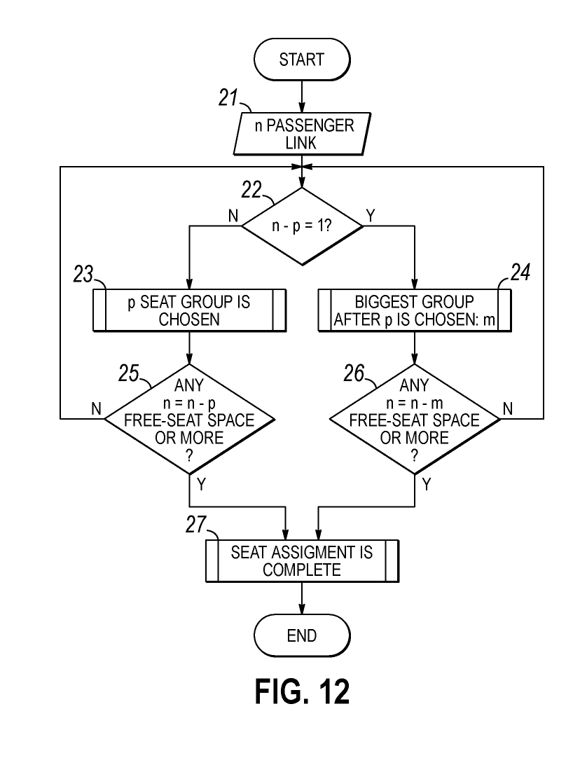

### Exemplary Split of a Group of Passengers During a Seat Assignment; FIG. 12 to FIG. 14

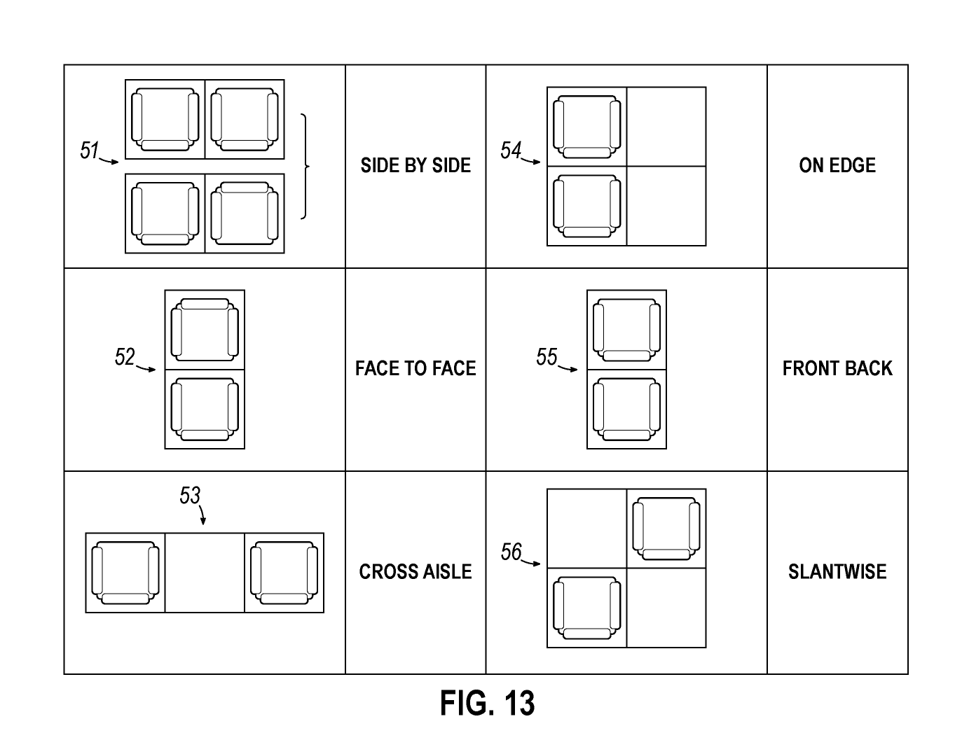

In some embodiments, the number of passengers in a group 21 may exceed the number of unoccupied seats in the largest available link-seat-configuration. As mentioned previously, a link-seat-configuration might be made up of any combination of unoccupied side by side 51, face to face 52, cross aisle 53, on edge 54, front to back 55 or slantwise 56 seat conjunctions, as illustrated by FIG. 13. In such a case, the group 21 is split in order to prevent a passenger of the group 21 from being seated alone, i.e., separated from the rest of his group 21. This split of the group 21 divides that group 21 into not necessarily equal subgroups for the seat assignment.

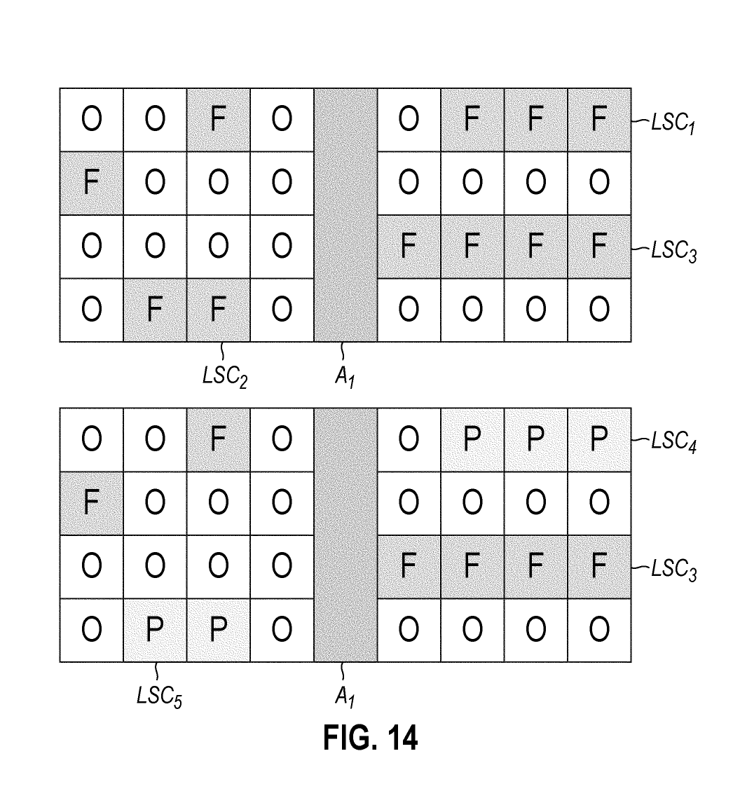

In some embodiments, the number of vertices in a group 21 might exceed the number of unoccupied seats in the largest link-seat-configuration by exactly one. In an exemplary embodiment, a group of five passengers 21 could have been formed and three unoccupied link-seat-configurations are available: one with four free side-by-side seats LSC₃, another one with three free side-by-side seats LSC₁ and still another one with two free side-by-side seats LSC₂, as illustrated in FIG. 14. This figure shows the exemplary arrangement of partially occupied seating space of a passenger-transport vehicle, separated by an aisle A1, illustrating this arrangement before and after seats are assigned to a group of five passengers. The illustrated boxes represent seats of a vehicle and each box corresponds to a seat. The seats are designated as free, passenger of group, and already occupied are respectively represented by the letters F, P, and O.

Because none of the link-seat-configurations illustrated by FIG. 14 provides enough free seating space to assign seats to the entire five-passenger group 21, a split has to be performed. In such a case, the successive activities 22, 24, and 26 sketched in the flow chart illustrated by FIG. 12 are performed to assign seats to the group 21. During the activity 22, a determination is made whether or not the number of passengers, n, in the group to be seated 21 exceeds the number of seats, p, in the largest available link-seat-configuration by exactly one.

Because the number of passengers in the group 21 is five and the largest available link-seat-configuration LSC₃ contains only four seats, the condition 22 is indeed fulfilled. Therefore, the next smaller available link-seat-configuration LSC₁ is chosen, which in this case contains three unoccupied seats, as illustrated by FIG. 14. Now, two passengers of the group 21 remain without an assigned seat. Thus, as a result of the activity 24, a remainder group out of these two passengers is formed. As illustrated by FIG. 14, a link-seat-configuration containing exactly two seats LSC₂ is available. Thus, the condition 26 is fulfilled for the remainder group and seats of the link-seat-configuration LSC₂ are assigned to the passengers of the remainder group. Thus, the previously unoccupied seats in the link-seat-configurations LSC₁ and LSC₂ turn into link-seat-configurations LSC₄ and LSC₅, respectively, and are now unavailable for further seat assignment. The splitting process is thereafter concluded by activity 27.

### Exemplary Split of a Group of Passengers During a Seat Assignment; FIGS. 12, 13 and 15

In some embodiments, the number of vertices in a group 21 might exceed the number of unoccupied seats in the largest link-seat-configuration by at least two. In an exemplary embodiment, a group of seven passengers 21 could have been formed and three unoccupied link-seat-configurations are available: one with three free side-by-side seats LSC₆, another one with two free side-by-side seats LSC₇, and still another one with two free side-by-side seats LSC₈, as illustrated by FIG. 15. This figure shows the exemplary arrangement of partially occupied seating space of a vehicle, separated by an aisle A2, illustrating this arrangement before and after seats are assigned to a group of seven passengers. The illustrated boxes represent seats of a passenger-transport vehicle, and each box corresponds to a seat. The seats are designated as free, passenger of group, and already occupied, respectively, by the letters F, P, and O. Because none of the link-seat-configurations illustrated by FIG. 15 provides enough free seating space to assign seats to the entire seven-passenger group 21, a split of that group 21 has to be performed.

In such a case, the successive activities 22, 24 and 26, sketched in the flow chart illustrated by FIG. 12 apply to assign seats to the seven-passenger-group 21. During activity 22, a determination is made whether or not the number of passengers in the group to be seated 21 exceeds the number of seats in the largest available link-seat-configuration by exactly one. Because the number of passengers in the group 21 is seven and the largest available link-seat-configuration LSC₆ contains only three seats, the number of passengers in the group 21 exceeds the number of seats in LSC₆ by four and, therefore, the condition 22 is not fulfilled.

Subsequently, the largest available link-seat-configuration LSC₆ is chosen, which in this case contains three unoccupied seats, as illustrated by FIG. 15. Now, four passengers of the group 21 remain without an assigned seat. Thus, a remainder group of these four passengers is formed, as a result of the activity 23. As illustrated by FIG. 15, there are two different link-seat-configurations LSC₇ and LSC₈, available, each with two seats. Thus, the number of passengers in the remainder group exceeds the number of seats in the largest available link-seat-configuration again by more than one; in this case, by two. Subsequently, the next smaller available link-seat-configuration is chosen 23. As LSC₇ and LSC₈ are both the next smaller available link-seat-configuration, one of them is arbitrarily chosen for the seat assignment. Assuming LSC₇ has been chosen, two passengers of the remainder group are assigned a seat of LSC₇. The residual-remainder group formed as a result of this iteration of activity 25 does not fulfill condition 22, as the difference between the number of passengers in the residual-remainder group and the number of seats in the largest available link seat configuration LSC₈ is zero. As illustrated by FIG. 15, the condition 26 is fulfilled because the remaining link-seat-configuration LSC₈ contains exactly the two seats necessary to seat the residual-remainder group of two passengers. Thus, the previously unoccupied seats in the link-seat-configurations LSC₆, LSC₇ and LSC₈ turn into link-seat-configurations LSC₉, LSC₁₀ and LSC11, respectively and are now unavailable for further seat assignment. The splitting process is thereafter concluded by activity 27.

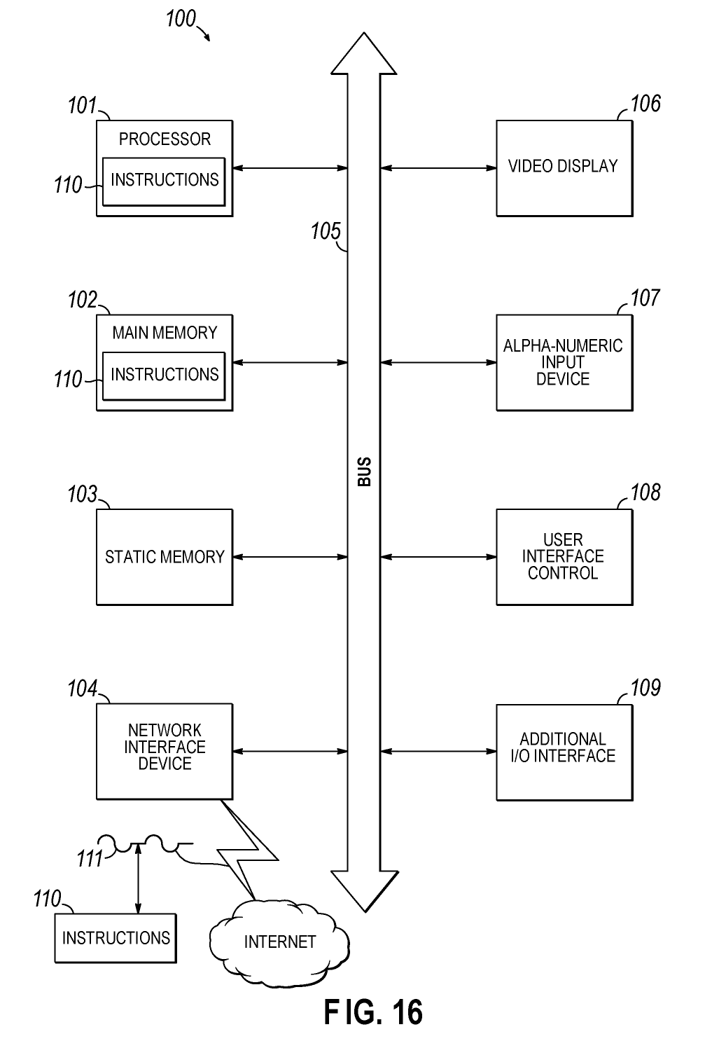

### Computer System; FIG. 16

FIG. 16 is a diagrammatic representation of an exemplary computer system 100 arranged to execute a set of instructions, to cause it to perform any of the methodologies used for a seat assignment and/or an optional split of a group formed during this seat assignment, as described herein. The computer system 100 includes a processor 101, a main memory 102 and a network interface 104. It further includes a static memory 103, e.g., non-removable flash and/or solid state drive and/or a removable Micro or Mini SD card, which permanently stores the software enabling the computer system 100 to execute its functions. Furthermore, it may include a display 106, a user interface control module 108 and/or an alpha-numeric and cursor input device 107. Optionally, additional I/O interfaces 109, such as card reader and USB interfaces may be present. In some embodiments the software programmed to carry out the method of assigning seats discussed herein is stored on the static memory 103; in other embodiments external databases, e.g., databases containing social network relation data, are used. The method of assigning seats discussed herein is performed via the network interface device 104.

An executable set of instructions (i.e., software) 110 embodying any one, or all, of the methodologies described above, resides completely, or at least partially, permanently in the non-volatile memory 103. When being executed, process data resides in the main memory 102 and/or the processor 101. The software 110 may further be transmitted or received as a propagated signal 111 through the network interface device 104 from/to a software server within a local area network or the Internet.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

The program code embodied in any of the applications/modules described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

These computer program instructions may also be stored in a computer readable medium that can direct a computer, other types of programmable data processing apparatus, or other devices to function in a particular manner, such that the instructions stored in the computer readable medium produce an article of manufacture including instructions that implement the function/act specified in the block or blocks of the flowchart and/or block diagram.

The computer program instructions may also be loaded onto a computer, other programmable data processing apparatus, or another device to cause a series of computations to be performed on the computer, the other processing apparatus, or the other device to produce a computer implemented process such that the executed instructions provide one or more processes for implementing the functions/acts specified in the flowchart and/or block diagram block or blocks.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the present invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for assigning seats in a passenger-transport vehicle to passengers, the method comprising:
subdividing, by a processor, the passengers into a plurality of groups, wherein the passengers included in each group are connected by social-network relations and have less than a maximum number of social-network relations to other passengers outside of the group, and breaks of the social-network relations between the passengers are minimized when the passengers are subdivided into the groups; and
in response to one of the passengers being excluded from the groups, determining, by the processor, one of the groups that includes at least one included passenger with at least one of the social-network relations to the excluded passenger to thereby increase the size of the group by adding the excluded passenger.

2. The method of claim 1 wherein subdividing the passengers into a plurality of groups comprises:
disregarding the passengers seated by a reservation link resulting from an existing booking when the passengers are subdivided into the groups.

3. The method of claim 1 wherein each group includes a minimum number of two passengers and a maximum number of three passengers, and each passenger with each group is connected to each other passenger with each group.

4. The method of claim 1 wherein the excluded passenger is added to the one of the groups that includes a fewest number of included passengers.

5. The method of claim 1 wherein the excluded passenger is added to the one of the groups to which the excluded passenger has the highest number of social-network relations to the included passengers in the group.

6. The method of claim 1 wherein the excluded passenger is added to the one of the groups by respecting a rule specifying a maximum number of passengers per each group.

7. The method of claim 1 further comprising:
in response to at least two passengers being excluded from the groups and at least one of the excluded passengers having more than the maximum number of social-network relations to the other passengers, forming a new group including the at least two excluded passengers.

8. The method of claim 1 further comprising:
in response to a number of the passengers in one of the groups being greater than a number of unoccupied seats in a largest link-seat configuration, splitting the passengers in the group.

9. A system for assigning seats in a passenger-transport vehicle to passengers, the system comprising:
at least one processor; and
a memory coupled with the at least one processor, the memory including program code configured to be executed by the at least one processor to cause the at least one processor to:
subdivide the passengers into a plurality of groups, wherein the passengers included in each group are connected by social-network relations and have less than a maximum number of social-network relations to other passengers outside of the group, and the passengers are subdivided into groups by minimizing breaks of the social-network relations between the passengers; and
in response to one of the passengers being excluded from the groups, determine one of the groups that includes at least one included passenger with at least one of the social-network relations to the excluded passenger to thereby increase the size of the group by adding the excluded passenger.

10. The system of claim 9 wherein the program code configured to subdivide the passengers into a plurality of groups comprises:
program code configured to be executed by the at least one processor to cause the at least one processor to disregard the passengers seated by a reservation link resulting from an existing booking when the passengers are subdivided into the groups.

11. The system of claim 9 wherein each group includes a minimum number of two passengers and a maximum number of three passengers, and each passenger with each group is connected to each other passenger with each group.

12. The system of claim 9 wherein the excluded passenger is added to the one of the groups that includes a fewest number of included passengers.

13. The system of claim 9 wherein the excluded passenger is added to the one of the groups to which the excluded passenger has the highest number of social-network relations to the included passengers in the group.

14. The system of claim 9 wherein the excluded passenger is added to the one of the groups by respecting a rule specifying a maximum number of passengers per each group.

15. The system of claim 9 wherein the program code is further configured to be executed by the at least one processor to cause the at least one processor to, in response to at least two passengers being excluded from the groups and at least one of the excluded passengers having more than the maximum number of social-network relations to the other passengers, form a new group including the at least two excluded passengers.

16. The system of claim 9 the program code is further configured to be executed by the at least one processor to cause the at least one processor to, in response to a number of the passengers in one of the groups being greater than a number of unoccupied seats in a largest link-seat configuration, splitting the passengers in the group.

17. A program product comprising:
a computer readable storage medium; and
program code stored on the computer readable storage medium and configured, upon execution, to cause at least one processor to assign seats in a passenger-transport vehicle to passengers by:
subdividing the passengers into a plurality of groups, wherein the passengers included in each group are connected by social-network relations and have less than a maximum number of social-network relations to other passengers outside of the group, and the passengers are subdivided into groups by minimizing breaks of the social-network relations between the passengers; and
in response to one of the passengers being excluded from the groups, determining one of the groups that includes at least one included passenger with at least one of the social-network relations to the excluded passenger to thereby increase the size of the group by adding the excluded passenger.
